(19) United States
(12) Patent Application Publication
(10) Pub. No.: US 2012/0146867 A1
(43) Pub. Date: Jun. 14, 2012

(54) Compact System of Multi-Beam Antennas

(76) Inventors: Jean-François Pintos, Saint Blaise Du Buis (FR); Philippe Minard, Saint Medard Sur Ille (FR); Ali Louzir, Rennes (FR); Dominique Lo Hine Tong, Rennes (FR)

(21) Appl. No.: 13/314,140

(22) Filed: Dec. 7, 2011

(30) Foreign Application Priority Data
Dec. 8, 2010 (FR) 1060240

(51) Int. Cl. H01Q 21/00; H01Q 13/02; H01Q 13/10

(52) U.S. Cl. 343/770; 343/893; 343/853; 343/844; 343/776

(57) ABSTRACT

The present invention relates to a system of multi-beam antennas comprising M radiating sources and P networks of N radiating elements, P being greater than 1 and N being an even whole number, the network elements being connected two by two via transmission lines of the same electrical length. In addition, the P networks are co-located at the centre of each network, the M radiating sources are each positioned at a distance Li from said centre, the distance Li being strictly less than the distance of the field called the far field and i varying from 1 to M.

This system can be used with MIMO type devices.

The present invention relates to a compact multi-beam antenna system, particularly a multi-beam antenna system that can be used in the context of wireless communications, more particularly in wireless domestic networks in which the conditions for propagation of electromagnetic waves are very penalising due to multiple paths.

### BACKGROUND OF THE INVENTION

For emerging applications such as wireless domestic networks, intelligent networks or similar type networks, the use of directive antennas, that is antennas able to focus the radiated power in a particular direction of the space are proving particularly attractive. However, the laws of physics impose a minimum size for antennas, this size being all the more significant as the antenna is more directive or as its operating frequency is low.

Up until now, the use of directive antennas has remained limited to applications operating at very high frequencies, often with fixed beams, and do not have size constraints such as those of radar applications or satellite applications. Thus, for these application types, antenna devices are known that generate multiple beams but are composed of numerous modules that are often complex and costly. Conversely, antennas devices called retro-directive antennas enable directive beams to be formed very simply in a privileged direction of the space. Retro-directive antenna networks are based on the fact that each antenna of the network receives the incident signal of a source with a characteristic path-length difference, that is to say a different phase. This phase difference is characteristic of the direction of the emitting source. In fact, so that the signal to be sent is emitted in the direction of the source, it suffices that the phase difference between each antenna at transmission is opposite to that in reception so as to anticipate the path-length difference on the return path.

Among retro-directive antennas, the most well known network is the network call the “Van-Atta” network which is described, notably, in the U.S. Pat. No. 2,908,002 of 6 Oct. 1959. As shown in FIG. 1, a Van-Atta type retro-directive network is constituted of a number of radiating elements 1a, 1b, 2a, 2b, 3a, 3b that are symmetric with respect to the central axis Oy of the network. The radiating elements are connected by pairs, the radiating element 1a being connected to the radiating element 1b, the radiating element 2a connected to the radiating element 2b, the radiating element 3a connected to the radiating element 3b, via transmission lines 1, 2, 3 having equal electrical lengths, the antennas being symmetrically opposed with respect to the central axis of the network. In this case, the phase shift induced by the transmission lines is thus the same on all the radiating elements and the phase difference between two consecutive radiating elements is the same in reception of the signal and in transmission of the signal retro-directed to the closest sign. The phase differences between the signals of radiating elements of the transmitting network are thus opposed to the phase differences between the signals of the radiating elements of the receiving network. A retro-directivity of the transmitted signal is thus obtained.

However, this method has a certain number of significant disadvantages. Hence, in order to obtain the retro-directivity of the signal, the front of the incident wave must be flat. In addition, the antenna network must be flat or more or less symmetric with respect to the network centre. As the front of the incident wave must be flat, it is necessary that the network of radiating elements is positioned in the field area far from the transmitter source. As a result, the applications of Van-Atta type networks have only been, up to now, satellite or radar type applications.

Following studies made on these types of retro-directive networks, it has been proposed, in the French patent application filed on the same day as the present entitled “System of multi-beam antennas”, to use the principle of a network of Van Atta type radiating elements, associated with sources located in the zone of the field close to the network, in order to produce a system of multi-beam antennas able to be used in wireless communications applications, notably in wireless domestic networks or in peer to peer type networks communicating via wireless links, more specifically, in the scope of systems called MIMO (Multiple Input Multiple Output) systems but also in antenna systems with a single antenna associated with processing systems operating with directive antennas.

### SUMMARY OF THE INVENTION

In this patent application, the system of multi-beam antennas comprises a network of N radiating elements, N being an even integer, the elements of the network being connected two by two via transmission lines. The system comprises in addition M radiating sources, M being an integer greater than or equal to 1, the radiating source(s) each being positioned at a distance Li from the centre of the network such that the distance Li is strictly less than the distance of fields called far fields.

The present patent application relates to an improvement of this network type enabling a better directivity of radiating beams to be obtained and to produce, as a result, a highly directive system of multi-beam antennas.

Thus, the purpose of the present invention is a system of multi-beam antennas comprising M radiating sources and P networks of N radiating elements, P being greater than 1 and N being an even integer, the elements of the network being connected two by two via transmission lines of the same electrical length, characterized in that the P networks are co-located at the centre of each network and in that the M radiating sources are positioned each at a distance Li from said centre, the distance Li being strictly less than the distance of the field called the far field and i varying from 1 to M.

The notions of far field and close field were notably described in an article of the IEEE Antennas and Propagation magazine, Vol. 46, No. 5—October 2004 entitled “On radiating zone band erase of short, λ/2 and λdipole” by S. Laybros and P. F. Combes.

Thus, when the source has a low dimension with respect to the wavelength, the distance Li between a source and the co-located centre of networks, is less than 1.6λ where λ is the wavelength at the operating frequency.

According to a preferred embodiment, the distance Li between a source and this co-located centre of networks is identical between the M sources and comprised between 0.3λ and 0.5λ.

According to another characteristic of the present invention, the M sources are arranged symmetrically with respect to the co-located source of P networks.

Preferably, each network of N radiating elements comprises, at the level of transmission lines, phase shifting means enabling the radiation patterns of said network to be controlled.

According to a preferred embodiment, the phase shift means are constituted by sections of transmission line.

Moreover, according to another characteristic of the present invention, the distance between two radiating elements of a network is a multiple of λ/4 where λ is the wavelength at the operating frequency.

According to a different characteristic enabling a super-directive system of antennas to be obtained, the distance between two radiating elements is less than λ/4 where λ is the wavelength at the operating frequency.

According to various embodiments, the radiating elements are selected via the monopoles, patches, slots, horn antennas or similar elements. Likewise, the sources are selected from among the monopoles, patches, slots, horn antennas or similar elements.

### BRIEF DESCRIPTION OF THE DRAWINGS

Other characteristics and advantages of the present invention will emerge upon reading the following description of several embodiments, this description being made with reference to the drawings attached in the appendix, in which:

FIG. 1 already described is a diagrammatic representation of a Van Atta type retro-directive network.

FIG. 2 is a diagrammatic view from above, of a first embodiment of a multi-beam antenna system in accordance with the present invention.

FIG. 3 shows the radiation pattern of the multi-beam antenna system of FIG. 2 when the beam is supplied by the source S1.

FIG. 4 is a diagrammatic view of a second embodiment of the present invention.

FIG. 5 shows radiating patterns of the embodiment of FIG. 4 when the networks are lit via the different sources of the system.

FIG. 6 is a diagrammatic view of a third embodiment of the present invention.

FIG. 7 is a front view of the system of FIG. 6 showing an embodiment of elements used for the sources or for the radiating elements.

FIG. 8 shows the radiation patterns of the multi-beam antennas system of FIG. 6 for different operating frequencies when the network is lit by the source S1.

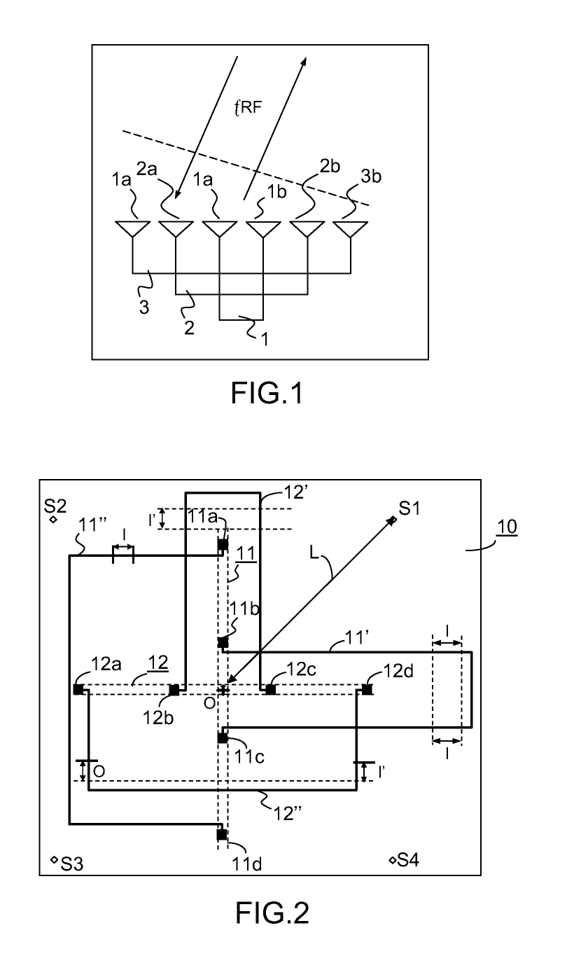

### DETAILED DESCRIPTION OF THE EMBODIMENTS OF THE INVENTION

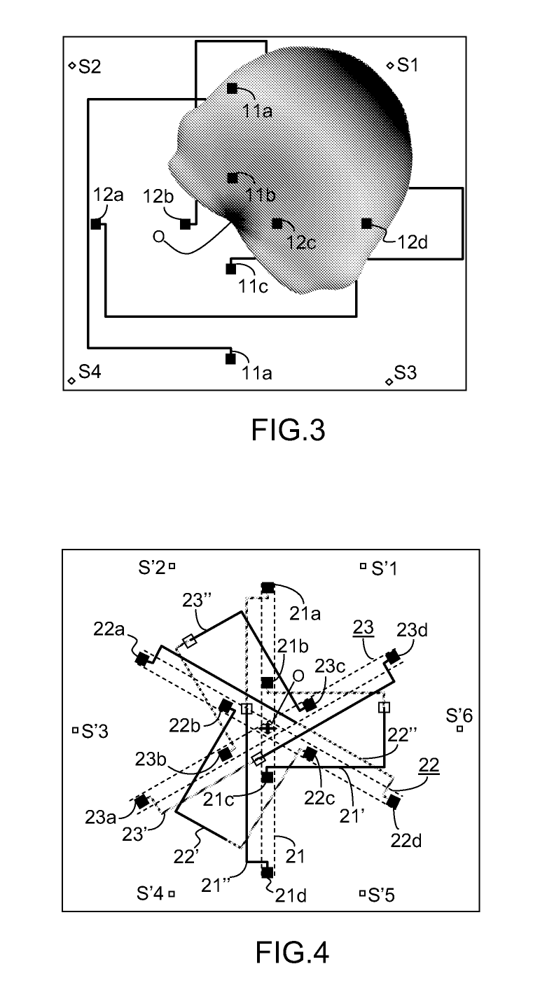

A description will first be given, with reference to FIGS. 2, and 3 of a first embodiment of a compact multi-beam antennas system in accordance with the present invention.

On a substrate 10 of large dimensions provided with a ground plane, an antenna system has thus been produced comprising two Van Atta type monopole networks and several sources positioned symmetrically around the networks. The monopoles are positioned in the field close to sources, as will be explained in more detail hereafter. In the embodiment of FIG. 2, the substrate 10 is a square substrate having a ground plane of dimensions 250×250 mm. It is produced preferably using FR4 type (εr=4.4 and tan(delta)=0.02) multi-layer standard substrate. The substrate has a thickness of 1.4 mm. As shown in FIG. 2, on the substrate 10 two retro-directive type networks have been produced, each constituted of four quarter wave monopoles spaced at a distance d that, in the embodiment shown, is selected to be equal to 0.2 λ0 with λ0 the wavelength at the operating frequency (in air, λ=λ0)

In the present invention, by retro-directive, is understood a network for which the elements return energy in the direction of arrival of a wave that is not necessarily plane.

More specifically, the first network 11 thus comprises four quarter wave monopoles 11a, 11b, 11c, 11d, the monopoles being connected two by two via the intermediary of power supply lines 11′ and 11″ produced in microstrip technology. Thus, the monopoles 11a and 11d are connected via the line 11″ and the monopoles 11b and 11c via the line 11′. Moreover, the power supply lines 11′ and 11″ have a same electrical length forming, as a result, a retro-directive network as explained above.

Moreover, as shown in FIG. 2, the network 11 of four monopoles has phase shift means enabling, as explained hereafter, the orientation of the radiation pattern to be modified. These phase shift means are constituted of line sections referenced “I” on the power supply lines 11′ and 11″.

On the substrate 10 a second retro-directive network 12 is also shown itself also constituted of four quarter wave monopoles 12a, 12b, 12c, 12d spaced from each other by an identical distance, namely d=0.2 λ0, in the embodiment shown. As for the first network, the monopoles are connected two by two, namely the monopoles 12a and 12d and the monopoles 12b and 12c, via transmission lines 12′ and 12″ of the same electrical length. The network 12 also comprises phase shift means formed of sections of microstrip line “I′”.

As shown in FIG. 2, the two networks are perfectly symmetrical and are co-located at the point O. It is clear to those skilled in the art that the networks having different distances between monopoles can also be used, like networks having each a different number of radiating elements, the only condition being that the number of radiating elements is an even number and that the network operates in a retro-directive way.

As shown in FIG. 2, the networks 11 and 12 are supplied by four sources S1, S2, S3 and S4 constituted of quarter wave monopoles. The sources are arranged symmetrically with respect to the two networks 11 and 12 and are located at a same distance L with respect to the centre O. The distance L between one of the sources and the centre O of co-location of the two networks is selected so that the monopoles of networks are located in the field close to sources, that is it is selected to be less than 1.6λ when the source is of small dimensions.

The embodiment shown in FIG. 2, was simulated using a 3D HFSS electromagnetic software of the Ansys company based on the finished elements method. As mentioned above the sources are constituted of monopoles of dimensions λ/4. The two networks comprising radiating elements formed by monopoles of height λ/4. The power supply lines are microstrip lines having a width of 3.57 μm to obtain a characteristic impedance of 50 Ohms on a thickness of 0.2 mm and the substrate is FR4. The dimension selected for the value L is such that L=0.5λ0.

Simulations show that with a system such as that represented in FIG. 2, by optimising the phase shifting means “I”, “I′” on the power supply lines, a radiation pattern is obtained for the source S1 as shown in FIG. 3. This radiation pattern that results from the contribution of the source S1 and of the two retro-directive networks has strong directivity in the direction of the source S1. The networks shown in FIG. 2 being symmetrical, similar results are obtained for the radiation patterns in the direction of sources S2, S3 and S4. The radiation patterns obtained being symmetrical with respect to the direction targeted, this enables a better decorrelation of signals at the level of antenna access. Moreover with the geometric symmetry of the source/network topology shown in FIGS. 2 and 3, four different directions can be targeted simultaneously with patterns that are similar and symmetrical, which enables an interesting application in systems such as MIMO systems.

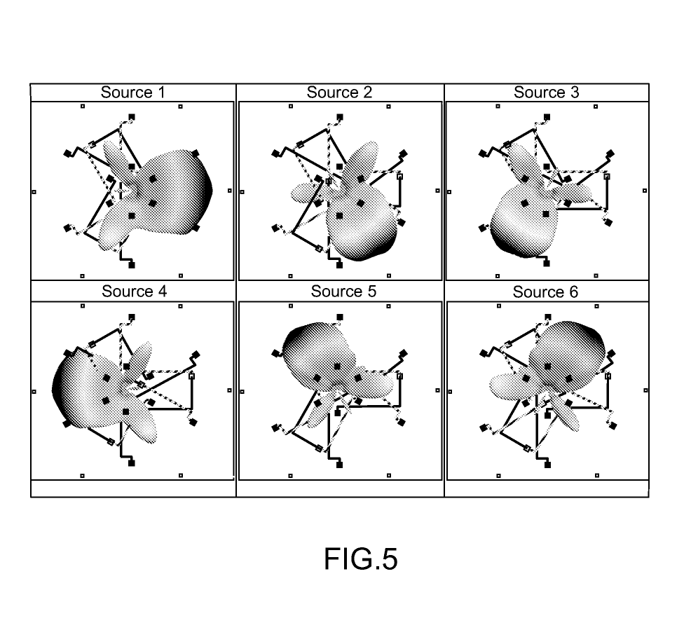

A second embodiment of the present invention will now be described with reference to FIGS. 4 to 5. In FIG. 4, is shown a system of antennas comprising three retro-directive networks 21, 22, 23. In this embodiment, the three networks 21, 22, 23 are networks of the same structure that are co-located at the centre 0. More specifically, each network 21, 22 or 23 comprises four radiating elements, namely four quarter wave monopoles 21a, 21b, 21c, 21d, 22a, 22b, 22c, 22d and 23a, 23b, 23c and 23d. In this case, the radiating elements constituted by monopoles of dimensions λ/4 are connected two by two via power supply line 21′, 21″, 22′, 22″ and 23′, 23″ constituting electric lines of the same length. For each network, the connection between the monopoles is carried out as in the first embodiment and the power supply lines 21′, 21″, 22′, 22″ and 23′, 23″ have a same length from one network to the other. Moreover, as shown in FIG. 4, the three co-located directive networks are supplied via six power supply sources S′1, S′2, S′3, S′4, S′5, S′6 constituted by quarter wave monopoles symmetrically distributed over the perimeter of three networks. More specifically, the distance between two monopoles of a retro-directive network is 0.2λ0, while the sources S′1, S′2, S′3, S′4, S′5, S′6 are at a distance L=0.4λ0 from the centre O. Thus the angular deviation between two sources is 60° and the angular deviation between two networks is also 60°. The three networks were produced in a standard manner on a low cost FR4 substrate and the two external layers of the multi-layer substrate were used to produce the power supply lines that, as shown in FIG. 4, are each constituted of two sections implemented on two planes of different metallization and connected by a metallic section, this to avoid cross-overs.

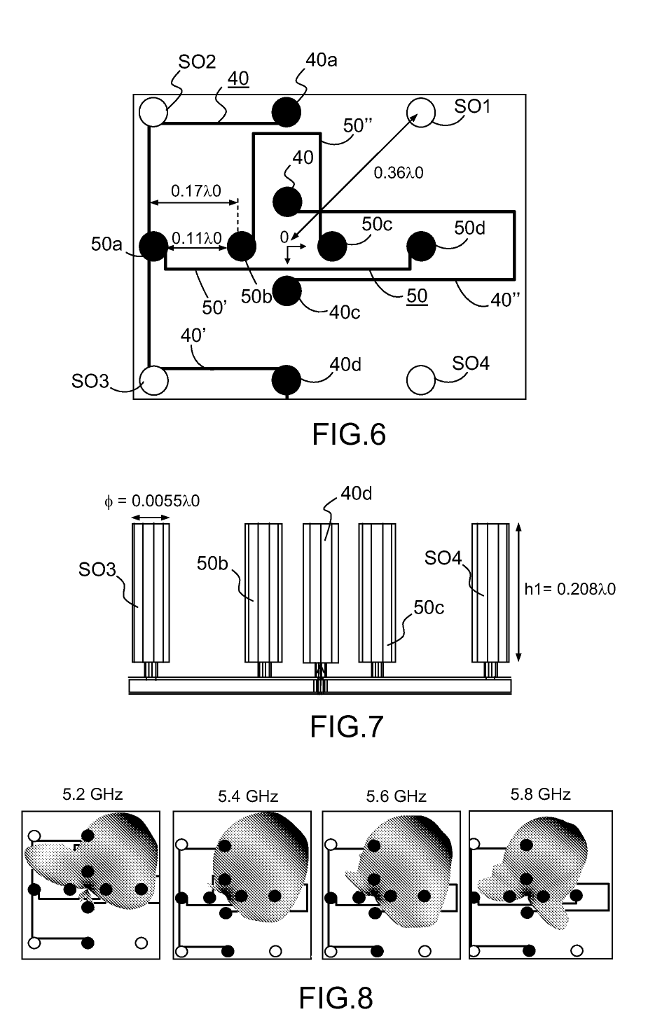

The system of antennas of FIG. 4 was simulated using the same software as for the system of antennas of FIG. 2 and the radiation patterns obtained for the different sources were represented in FIG. 5. The radiation pattern of each source in fact results from the contribution of the source itself and from the response of three retro-directive networks. The results obtained in FIG. 5 show that the different patterns obtained have a main directivity in the direction of the source. The secondary lobes obtained can be reduced and even cancelled using phase shifting means, namely additional line sections optimised in the power supply lines, as shown in the embodiment of FIG. 6.

The system of multi-beam antennas of FIG. 4 is an extremely compact system as it has a diameter of 0.8λ0 at 5.5 GHz. It enables several directive beams to be obtained simultaneously.

A third embodiment of the present invention will now be described with reference to FIGS. 6 to 8, enabling a more compact system of multi-beam antennas to be obtained and having an improved directivity. In the case of the embodiment of FIG. 6, two co-located retro-directive networks 40 and 50 are used. The first network comprises quarter wave monopoles 40a, 40b, 40c and 40d connected two by two, as in the preceding embodiments, via power supply lines 40′ or 40″ produced in microstrip technology and having identical electrical lengths. Likewise, the second network 50 is constituted by quarter wave monopoles 50a, 50b, 50c and 50d connected two by two via power supply lines 50′ and 50″ in microstrip technology and having identical electrical lengths. The two networks are perpendicular to one another, in the embodiment shown. They are lit by four sources SO1, SO2, SO3 and SO4 arranged symmetrically with respect to the two networks.

In accordance with the embodiment of FIG. 6, the network monopoles are positioned at a distance d=0.11λ0 from one another and the sources SO1, SO2, SO3, SO4 are located at a distance L=0.36λ0 from the centre O of co-location of the two networks.

As shown in FIG. 7, in order to optimize the coupling between the source monopoles, namely SO3 and SO4 for example, and the network monopoles, namely the monopoles 50b, 40d, and 50c as shown in FIG. 7, the monopoles have a polygonal section, mainly a hexagonal section in the embodiment shown. The monopoles have a height h1=0.208λ0 and a diameter Φ=0.0055λ0. It is evident to those skilled in the art that other profiles can be considered to optimize the coupling between the different elements.

A system of multi-beam antennas as shown in FIG. 6 was simulated using the software already mentioned above. The results of the simulation for a lighting of the source SO1 at different operating frequencies, are shown in FIG. 8.

On FIG. 8, it can be seen that between 5.4 and 5.8 GHz, the radiation patterns have a directivity in the direction of the selected source, namely SO1 in the embodiment which enables a super directive system of multi-beam antennas.

It is evident to those skilled in the art that the embodiments described above can be modified without falling outside the scope of the present invention. In particular the radiating elements constituting networks can be selected from among monopoles, patches, slots or horn antennas. Likewise, the sources can also be selected from among the monopoles, patches, slots, or horn antennas. These elements must have an omnidirectional radiation in the azimuthal direction. Moreover, the networks have been represented with four radiating elements. The number of elements can be different but it must be even. The sources can be at a same distance or at different distances from the co-location centre. The phase shift means used can be active or passive elements. Namely in compliment to or in substitution of line sections, filters or other elements can be integrated that will be selected to optimize the radiation pattern.

1. System of multi-beam antennas comprising M radiating sources and P networks of N radiating elements, P being greater than 1 and N being an even integer, the radiating elements of the network being connected two by two via transmission lines of the same electrical length, wherein the P networks are co-located at the centre of each network and in that the M radiating sources are positioned each at a distance Li from said centre, the distance Li being strictly less than the distance of the field called the far field and i varying from 1 to M.

2. System of multi-beam antennas according to claim 1, wherein the M sources are arranged symmetrically with respect to the co-located centre of P networks.

3. System of multi-beam antennas according to claim 1, wherein each network of N radiating elements comprises at transmission line level passive or active phase shift means, enabling the radiation patterns of said network to be controlled.

4. System of multi-beam antennas according to claim 3, wherein the phase shift means are constituted of sections of transmission line.

5. System of multi-beam antennas according to claim 1, wherein the distance Li between a radiating source and the co-located centre of networks is less than 1.6λ where λ is the wavelength at the operating frequency.

6. System of multi-beam antennas according to claim 5, wherein the distance Li between the radiating source and the co-located centre of networks is identical for the M sources and is comprised between 0.3λ and 0.5λ.

7. System of multi-beam antennas according to claim 1, wherein the distance between two radiating elements of a network is a multiple of λ/4 where λ is the wavelength at the operating frequency.

8. System of multi-beam antennas according to claim 1, wherein the distance between two radiating elements is less than λ/4 where λ is the wavelength at the operating frequency.

9. System of multi-beam antennas according to claim 1, wherein the radiating sources are selected from among the monopoles, patches, slots and horn antennas.

10. System of multi-beam antennas according to claim 1, wherein the radiating elements are selected from among the monopoles, patches, slots and horn antennas.
